(19) United States
(12) Patent Application Publication
(10) Pub. No.: US 2025/0217429 A1
(43) Pub. Date: Jul. 3, 2025

(54) SYSTEM FOR LINKING DIGITAL CONTENT WITH PHYSICAL BOOKS

(71) Applicant: TUK ApS, Aalborg SØ (DK)

(72) Inventor: Kasper Engstrøm LYHNE, Aalborg SØ (DK)

(73) Assignee: TUK ApS, Aalborg SØ (DK)

(21) Appl. No.: 18/866,826

(22) PCT Filed: May 19, 2023
(86) PCT No.: PCT/EP2023/063536

§ 371 Date: Nov. 18, 2024

(30) Foreign Application Priority Data
May 19, 2022 (DK) PA202270268

(51) Int. Cl. G06F 16/955; G06K 7/10

(52) U.S. Cl. CPC G06F 16/955; G06K 7/10297

(57) ABSTRACT

A system including: a plurality of ID tags with a unique identifier, the ID tag being configured to be scannable by a scanner to identify the unique identifier, at least some ID tags being physically attached to a plurality of physical books and at least some ID tags not being physically attached to physical books, a network connected service, the service including a database which includes data representing a plurality of content links between unique identifiers of ID tags and files including digital content, the system being arranged to allow a plurality of digital devices to interact with the system, each of the digital devices including a speaker and/or a display to play and/or display digital audio content and/or digital visual content respectively, a communication unit to allow the digital device to communicate with the network connected service and a scanner arranged to scan an ID tag.

The current invention relates to a system for linking digital content with physical books.

For the sake of the current specification, the term “physical book” should be understood as a traditional paper based book. This could be hard cover, soft cover, spiral bound, etc. The main feature being a bundle of paper pages. The physical books could be of any known form, for example children's picture books, fiction novels, non-fiction books, comics, textbooks, etc.

For the sake of the current specification, the term “digital content” should be interpreted broadly. For example, the content could be video, sound, graphics, etc. Furthermore, it should be noted that the content can be provided in different formats. Two examples of digital content in a specific format are audio books and e-books. While the concept of an audio books and the concept of an e-book should be well known, they are described in more detail later on in this specification.

### DESCRIPTION OF RELATED ART

It is well known in the art to make digital content which is related to a physical book. One typical form of digital content is an audio recording of a book, often called an “audio book”. An audio book allows people to listen to the recording of the book instead of reading it directly. Audio books have become more and more popular, especially due to new streaming services where people can get unlimited access to a large number of different audio books for a fixed monthly price. Audio books are popular for many reasons. One non-limiting example of a reason for the popularity of audio books is that people who are on the move and who would otherwise have difficulty in reading a book can just listen to the audio book while moving about, for example while mowing the lawn, washing the dishes or driving their car. This can make the audio book more accessible than a physical book for many people.

In the prior art, it is most typical that the audio recording of the book and the physical book are two separate items and are therefore also purchased separately. Users will typically buy either the audio book or the physical book but most often not both since the book and the audio recording both have a cost and the user might not want to pay the price of two so related products. However, in some cases, it could be desirable to associate the audio recording directly with the physical book. This could be for example, in the case where a user wishes to have access to both the audio book and the physical book. Buying two separate products is more expensive, but by coupling the audio book to the physical book, new bundling possibilities are opened up.

Another example of an application where it would be desirable to link the audio book to a physical book is for children's books, where a child can listen to an audio recording of a book and follow along with the words in the physical book itself. This will make the book more accessible to the child and also help the child learn to read better. This will also allow additional visual content, for example pictures in a picture book, to enhance the experience of listening to the audio recording. It can also make reading more fun for the child.

Making reading more fun and accessible can also be relevant for adults. One option is for adults who are learning a new language. Reading the book while hearing the audio recording can make learning the new language easier. Some readers might also be intimidated by large books with many pages and lots of complex words. However, listening to the book while reading along could make the reading process more enjoyable for adult users. Furthermore, there are currently many people using audio books who are not also using physical books. Providing linked products could help people bridge the gap to physical books by making it easier to approach books and help to improve their reading skills.

For the sake of this specification, the term “audio book” should be understood as a digital file with an audio recording of the book. This is typically an audio recording of a person or persons reading the book aloud. The audio recording could also be a sound file which is generated on the fly via a text to speech algorithm. Audio books can also include additional audio features like sound effects, music, etc. Audio books come in many different formats. At the moment, the standard for audio book formats is in development and there is no single well developed and accepted standard for audio books. There are different proposed standards which are being developed at the current time. Some audio book formats include content information, such as chapter headings, table of contents, etc. . . . Some audio books are split into multiple files representing individual chapters while some audio books are just one large file comprising a single audio recording of the entire book. It is expected that audio book formats will develop over time as audio books evolve.

Another form of digital content related to physical books is a digital version of the book, often called an “e-book”. This form of digital content is typically read on a digital display, for example via an e-book reader, a mobile phone or a tablet. As with audio books, e-books are also sold as separate items and are also associated with a cost and in many cases, the price of the e-book is the same as the physical book. As such, it is seldom that people will buy both the e-book and the physical book. However, in many cases, it could be an advantage to have access to both the e-book and the physical book. Reading a physical book is often times more satisfying than reading an e-book on an e-book reader. Also, having a physical book in a book shelf is rewarding for some readers. However, when travelling, an e-book reader is much handier than taking along a bunch of physical books, since the e-book reader can store multiple e-books in a small travel handy package. E-book readers also have additional beneficial features like word lookup for defining difficult words, reading statistics, highlighting, note taking, etc.

For the sake of this specification, the term “e-book” should be understood as a digital version of a physical books suitable for display on a digital display. E-books typically come in two main versions, a first version which mainly comprises the text of the physical book, without any specific formatting. This format is typically used for fiction books where the text is the main component and there is no specific formatting of value. A second version is a true digital version of the physical book where both the format and the layout is captured and then displayed to the user in the predefined format. This format is typically used for children's books where there are pictures and text which need to be arranged in a particular format for the book to give value.

As described above, physical books, audio books and e-books all have unique advantages. Hence, making a bundle of a digital book, an audio book and a physical book would be interesting as this opens up the content for the user in many different ways. When driving to work, the user could listen to the audio book. When at home the user could read the physical book and when travelling, the user could take the e-book and read it on an e-book reader.

Multiple solutions for linking audio content with physical books are known in the art. One example is US2003162475 where an electronic tag is integrated in a cover of a book. The tag has an identifier which points to an audio file. A dedicated audio device with a scanner is used to scan the tag and find the audio file. The audio file can then automatically be played back. However, this system is rather limited in what can be implemented as it is locked to the data which can be stored on the dedicated audio device. Another similar example is provided in U.S. Pat. No. 6,330,427.

Furthermore, in the prior art, the systems which link audio content and physical books are provided with books which are specifically made for the purpose. It is not in general possible to link an already printed physical book with digital content after the manufacture and/or sale of the book to a customer or after the book has left the publisher.

Linking e-books to physical books is not known in the art as it has previously been thought that people would either want the physical book or the e-book, but not both. Linking both e-books and audio books to physical books is also not known in the art.

### SUMMARY OF THE INVENTION

It is therefore a first aspect of the current invention to provide a system as mentioned in the opening paragraph which is more flexible than the prior art systems.

A second aspect of the current invention is to provide a system as mentioned in the opening paragraph which allows for simpler operation than the prior art systems.

A third aspect of the current invention is to provide a system as mentioned in the opening paragraph which allows for more functionality than the prior art systems.

A fourth aspect of the current invention is to provide a system as mentioned in the opening paragraph which allows for new business models related to physical books.

A fifth aspect of the current invention is to provide a system as mentioned in the opening paragraph which allows digital content to be associated with already existing physical books.

A sixth aspect of the current invention is to provide a system which can link e-books and physical books.

A seventh aspect of the current invention is to provide a system which can link e-books, audio books and physical books.

An eighth aspect of the current invention is to provide a system which can enforce access rights to digital content.

One or more of these aspects are provided at least in part via a system as mentioned in the opening paragraph which comprises a plurality of ID tags, each of the ID tags of said plurality of ID tags comprising a unique identifier associated with the ID tag, said ID tag being configured to be scannable by a scanner to identify the unique identifier associated with the ID tag, at least some ID tags from said plurality of ID tags being physically attached to a plurality of physical books and at least some ID tags of said plurality of ID tags not being physically attached to physical books, a network connected service, said service comprising a database which comprises data representing a plurality of content links between unique identifiers of ID tags of said plurality of ID tags and files comprising digital content, said system being arranged to allow a plurality of digital devices to interact with the system, each of said digital devices comprising a speaker and/or a display to play and/or display digital audio content and/or digital visual content respectively, a communication unit to allow the digital device to communicate with the network connected service, a scanner arranged to scan an ID tag of said plurality of ID tags and identify the unique identifier associated with the scanned ID tag, and a microprocessor arranged to access the network connected service via the communication unit, said network connected service being configured to execute a content retrieving procedure, said content retrieving procedure facilitating, at least in part, the steps of a digital device contacting the network connected service, the digital device uploading a unique identifier to the network connected service and the digital device retrieving a file comprising digital content which is linked with the uploaded unique identifier via the data representing the plurality of content links in the database.

In this way, a system is provided which allows for flexible operation and allows for many different business models to be implemented in an easy manner. The prior art has not successfully provided systems for connecting digital content and physical books on a large scale and in a flexible manner. The system according to claim 1 works with both audio books and e-books. In this way, flexible licensing systems can be provided to link physical, audio and e-books in a simple manner. Furthermore, the system according to claim 1 can work with previously published and sold books.

It should also be noted that the current invention relates to a system of interconnected elements and procedures. Some of the components of the system in some embodiments can be known elements, for example mobile telephones, but they interact with the remaining components of the system to provide a new and inventive functionality.

The flexibility in the currently proposed system is provided in that all the “link” information between the ID tags and the book is provided in the database on the internet connected server. Hence, ID tags can be added to books at the factory, without needing to program the tags in any way. The “links” can then be established later on if desired. Likewise, ID tags can be added to already published books either at the publisher's stock location, at a store or by a private consumer at their home. After an ID tag is added to the book, a “link” can be established in an easy way in the database. Hence, all physical books, both books which will be printed in the future and books already printed and already sold can easily be integrated into the system, just by attaching an ID tag with a unique identifier as proposed by the system according to the current invention.

According to this specification, the phrase “physically attached to” should be understood as one object which is attached directly to another object via a physical connection. The attachment could take different forms. In some embodiments, the attachment is via an adhesive. In another form, the ID tag is embedded inside the object itself. Hence, physically attached to can include integral attachment, permanent attachment, removable attachment, etc.

According to the current specification, the phrase “network connected service” should be understood as one or more servers or service providing systems connected to a network over which the digital devices can access the network connected service to perform actions. Typically, the network connected service will be an internet connected server and the digital devices will contact the server over the internet. The server could comprise multiple servers, for example one server having the files and another server having the database. There could also be different file servers and different database servers for different countries, different publishers, etc. An internet connected server can also be called a cloud server. The network connected service could also be a distributed server, for example a block-chain based system. The database can be many formats, also distributed files, etc. The term database should therefore be interpreted broadly as a data storage system which is structured in a known way.

According to the current specification the term “file” should also be understood broadly since data associated with digital content can be stored in different formats. For example, an e-book could be stored in a database table instead of in a particular file on a file system. But the end result is similar to a normal file. It should also be noted that in this specification, it is written that there is a link between a unique identifier and a file comprising content. However, this does not imply that the link needs to be a direct link. As such, the link could comprise multiple levels of links. For example a unique identifier could be linked to a book record with a particular book ID and the particular book record could comprise a first link to an audio file and a second link to an e-book file.

In some embodiments, the unique identifier is stored in the ID tag. In some embodiments, the unique identifier is stored on the ID tag. In some embodiments, the unique identifier is printed on a surface of the ID tag. In some embodiments, the unique identifier is both stored in the ID tag and printed on a surface of the ID tag. In some embodiments, at least some of the ID tags of the plurality of ID tags comprise a second unique identifier which is different from the unique identifier. In some embodiments, the unique identifier and the second unique identifier both link to the same digital content.

In some embodiments of the system, the plurality of digital devices which are able to interact with the system comprises: audio devices with a speaker, and display devices with a display, said data representing a plurality of content links between unique identifiers in ID tags of said plurality of ID tags and files comprising digital content comprising audio content links between unique identifiers and files comprising audio recordings, and display content links between unique identifiers and files comprising e-books, said audio devices being arranged to play the files comprising audio recordings and said display devices being arranged to display the files comprising e-books. By combining both audio files and e-book files in the same system, a very flexible system is provided with great benefits to the user.

In some embodiments, the system comprises dedicated audio devices and/or dedicated display devices. According to this specification, a dedicated digital device is a device which is specifically designed as a part of the system. This would be in contrast to a general purpose digital device, for example a mobile phone or a tablet. In some embodiments, the system comprises both dedicated audio devices and dedicated display devices. In some embodiments, at least some of the digital devices comprise both a speaker and a display. In some embodiments, at least some of the digital devices are mobile telephones. In some embodiments, the plurality of digital devices comprises both dedicated audio devices and mobile phones.

In some embodiments, at least some ID tags of said plurality of ID tags are stickers comprising a foil wafer having a first main surface with an adhesive suitable for physically attaching the foil wafer to a surface of a physical book. In some embodiments, the foil wafer further comprises a second main surface being a free surface which is exposed when the foil wafer is attached to a surface of an object, for example a physical book. In some embodiments, the free surface has a scannable code. In some embodiments, the foil wafer comprises a scannable code embedded in or integrated with the foil wafer. In some embodiments, an RFID chip is embedded in the foil wafer.

In some embodiments at least some ID tags of said plurality of ID tags are embedded in a physical book. According to this specification, the phrase “embedded in” should be understood as the structure of the ID tag being an integrated part of the book, for example embedded in the structure of the cover or in the spine of the book. This is in contrast to a solution where the ID tag is a sticker which is applied to and fastened to a surface of the physical book, for example the inside or outside of the cover, a page, etc. of the physical book. In one embodiment, the plurality of ID tags comprises a first type of ID tag which is embedded in a part of a physical book, for example the cover or the spine, and a second type of ID tag which is in the form of a sticker attached to a surface of a physical book. In one embodiment, the two types of ID tags are scannable by the same type of scanner. In one embodiment, the two types of ID tags both comprise an RFID chip which is scannable by an RFID scanner. In another embodiment, the two types of tags both comprises a 2D bar code on a visible surface which is scannable by a camera or the like. In some embodiments, at least some ID tags of said plurality of ID tags are physically attached to physical elements which are not physical books. In some embodiments, said physical elements could be plastic figures and the ID tag could be embedded in the plastic figures. In this way, a system could be provided which has tags attached to physical books via a sticker, tags which are embedded in physical books and tags which are embedded in physical elements other than physical books, for example plastic figures or tokens.

In some embodiments at least some ID tags of said plurality of ID tags are “non-linked” ID tags where the database does not comprise a content link between the unique identifier associated with the “non-linked” ID tags and any particular files comprising digital content or the database comprises a content link between the unique identifier associated with the “non-linked” ID tags and a placeholder digital content.

According to this specification the term “placeholder digital content” should be understood as digital content which is not associated with any one particular book, but is a more generic digital file. In some embodiments, multiple different physical books with “non-linked” tags will link to the same “placeholder digital content”. In some embodiments, the placeholder digital content could be an audio recording with information about the system. In some embodiments, the placeholder digital content could be an image or a video with information about the system. In some embodiments, the placeholder digital content could be a link to a webpage with information about the system.

In some embodiments, at least some of said “non-linked” ID tags are attached to physical books. In some embodiments, at least some of said physical books with attached “non-linked” ID tags are provided for sale in a shop. In some embodiments, at least some of said “non-linked” ID tags are packaged in packaging suitable for sale in a physical store and/or suitable for shipping via mail. In some embodiments, a set of two or more “non-linked” ID tags are packaged together in a packaging suitable for sale in a physical store and/or suitable for shipping via mail. In some embodiments a set of more than one and less than 10 “non-linked” ID tags are packaged together in a packaging suitable for sale in a physical store and/or suitable for shipping via mail. In some embodiments, the system comprises a kit of parts comprising a packaging, and at least one physical book and at least one non-linked ID tag arranged inside the packaging, said at least one non-linked ID tag not being physically attached to the physical book.

In some embodiments, said network connected service is configured to execute at least a part of a content link creation procedure which creates a content link between a specific file comprising digital content and a unique identifier associated with an ID tag of said plurality of ID tags. In some embodiments, the content link is created by storing data in the database representing the content link between the unique identifier associated with the ID tag and the specific file comprising digital content.

In some embodiments, the content link creation procedure is triggered by at least one of said plurality of digital devices. In some embodiments, at least one of said plurality of digital devices is arranged to upload to the network connected service a unique identifier associated with an ID tag scanned by said digital device together with data representing an ID of a physical book, after which the network connected service will generate a content link between the unique identifier associated with said ID tag and a specific file comprising digital content related to the ID of the physical book. In some embodiments, the data representing an ID of a physical book includes a picture of the cover of the book, a text string comprising an ISBN number or a picture of an ISBN bar code.

In some embodiments, at least some of the plurality of digital devices comprise an internal storage device to store the digital content locally on the digital device and in that the network connected service is arranged to allow the digital device to download the digital content. In some embodiments, the system is arranged such that at least some of the plurality of digital devices are arranged to stream the digital content over the internet and in that the network connected service is arranged to stream the digital content to said at least some of said plurality of digital devices.

In some embodiments, the database further comprises data representing information about a plurality of user accounts and in that the database further comprises data representing user account links between at least some unique identifiers associated with at least some ID tags of said plurality of ID tags and at least some user accounts in the database. In some embodiments, the system is configured to execute a routine for adding a user account link between a unique identifier associated with an ID tag and a user account in the database. In some embodiments, the system is configured to execute a routine for removing a user account link between a unique identifier associated with an ID tag and a user account in the database and adding a new link between the unique identifier associated with an ID tag and a different user account. In some embodiments, the system is configured to prevent creation of user account links between a single unique identifier and multiple user accounts. In this way, a single unique identifier can only be associated with a single user account and once an ID tag is linked to a particular user account, the ID tag cannot be linked to other user accounts. In some embodiments, the system is configured to prevent a user from retrieving digital content linked to by a content link from a unique identifier when no user account link exists between said unique identifier and the user account of the user.

In some embodiments, said database comprises data representing links between digital devices and user accounts. In this way, a digital device can be linked to a particular user account and actions of such a linked digital device can be linked to or associated with said user account.

In some embodiments, the database comprises data associated with each ID tag of said plurality of ID tags which represents a type of tag and/or a tag status to define the way in which the system treats the tag. In some embodiments, the type of tag could be chosen from a set of values comprising action or content. In some embodiments the tag status could be chosen from a set of values comprising open and locked. In some embodiments, the system is arranged to check for user rights when reading a tag with a status of locked. In some embodiments, the system is arranged not to check for user rights when reading a tag with the status of open.

In some embodiments, the network connected service is configured to execute a routine assigning user access to digital content linked to by the network connected service.

In some embodiments, the database further comprises data representing action links between unique identifiers associated with some ID tags of said plurality of ID tags and predefined procedures. In this way, certain unique identifiers and thereby certain ID tags can be linked to a predefined procedure for a digital device to perform when obtaining a unique identifier associated with an ID tag by scanning the ID tag with the digital device. In some embodiments, the system is configured to execute a procedure where the database is changed such that an action link associated with a unique identifier is replaced with a content link. In this way, an ID tag can on first scanning cause the digital device and/or the network connected service to perform a predefined procedure and then be changed afterwards to link to a specific digital content.

In some embodiments, at least one predefined procedure comprises the steps of: receiving data representing an ID of a user account from a digital device and adding data representing credits to the user account, said credits being suitable for purchasing digital content, the amount of said credits to be added being defined in the at least one predefined procedure. In some embodiments, after adding the credits to the user account, the link between the pre-defined procedure and the unique identifier is deactivated or deleted in the database. In some embodiments, the data representing an ID of a user account is an ID of a digital device associated with a user account and the network connected service identifying data representing an ID of a user account which is associated with the ID of the digital device.

In some embodiments, the ID tags of said plurality of ID tags comprise RFID chips and in that the scanners of the digital devices are RFID readers. In one embodiment, the scanner is an NFC scanner and the ID tags comprise an RFID chip which is suitable for being read by an NFC scanner.

In some embodiments, the database comprises data representing a plurality of book information records, said book information records comprising information related to the title of the book as well as the edition/version information. In some embodiments, the book information records comprise a link or multiple links to a file or files containing digital content related to the title and/or the edition/version information. In some embodiments, the book information records comprise a link to a file comprising an audio book as well as a link to a file comprising an e-book. In some embodiments, the same title could have links to different versions of audio books and/or different versions of e-books depending on the edition/version of the physical book. In some embodiments, the link between a unique identifier and a digital content file comprises a first link between the unique identifier and a book information record and a second link between a book information record and a digital content file.

The current specification also discloses a second invention relating to a registering device for use with a system as described above, said registering device comprising a scanner suitable for scanning a unique identifier associated with an ID tag of said plurality of ID tags physically attached to a physical book, a book identifying unit arranged to identify data representing the title and edition/version of a physical book, a communication device suitable for communicating with a network connected service of a system as described above, and a microprocessor configured to upload the scanned unique identifier and the identified data representing the title and edition/version of the physical book to the network connected service. In some embodiments, the book identifying unit comprises a manual input device where a user manually inputs the title and version/edition of a book prior to scanning an ID tag.

In some embodiments, the registering device is a portable device comprising a fastening mechanism for fastening said registering device to a machine in the book production process. In some embodiments, the registering device is attached to a machine which is arranged to attach stickers to a surface of physical books.

In some embodiments, the book identifying unit comprises a camera configured to take one or more pictures of the cover of a physical book and/or of the ISBN bar code on a physical book. In some embodiments, the microprocessor is configured to upload a picture of the cover of the physical book and/or the ISBN bar code together with the unique identifier associated with the scanned ID tag to the network connected service where the network connected service is configured to execute or perform (at least a part of) a procedure to match the uploaded picture with a title and edition/version of a physical book. In some embodiments, the registering device comprises a camera configured to take pictures of the cover of a book or of the ISBN bar code on a book and where the book identifying unit is configured to execute a procedure to match a picture of the book with a title and edition/version of the book and upload data representing the identified title and version/edition information to the network connected service with the scanned unique identifier of the ID tag.

In some embodiments, the registering device has a flexible mount for the camera and/or a flexible mount for the scanner.

In some embodiments, the registering device is configured to be in wireless communication with the scanner and/or in wireless communication with the camera.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows a top perspective view of one embodiment of a portable dedicated audio device for use with the system according to the current invention.

FIG. 2 shows a perspective bottom view of the audio device of FIG. 1.

FIG. 3 shows an exploded perspective view of the audio device of FIG. 1.

FIG. 4 shows a schematic perspective view of a book with an RFID tag and the audio device of FIG. 1 arranged away from the RFID tag.

FIG. 5 shows a schematic perspective view of the audio device of FIG. 1 arranged on top of the book of FIG. 4.

FIG. 6 shows a schematic perspective view of the audio device of FIG. 1 away from the book of FIG. 4, but playing an audio file associated with the RFID tag read from the book.

FIGS. 7a-7d show a schematic view of a procedure for activating a tag attached to a physical book.

FIG. 8 shows a perspective view of a card with a removable ID tag.

FIG. 9 shows a schematic perspective view of a package suitable for selling in a store comprising three physical books, three cards with pre-paid tags and five non-linked ID tags.

FIG. 10 shows a schematic perspective view of an embodiment of a registering device.

FIG. 11 shows a perspective view of a second embodiment of a dedicated audio device suitable for use with the system according to the current invention.

### DETAILED DESCRIPTION OF THE EMBODIMENTS

The system according to the current invention can comprise a number of different functionalities depending on the desire of the system provider. In the description below, an embodiment of one system is described which comprises many different features. However, as should be clear from the claims and the introductory portion of this specification, the scope of protection covers both complex systems with many different functionalities as described below as well as more simple systems comprising only a select few of the functionalities described below.

In order to describe the system in detail, the description below is split into three separate parts. The first part of the description discusses one embodiment of the use of the system by the end user of the system to provide context. The second part of the description discusses one embodiment of the backend to the system and how this particular embodiment of the system is arranged to provide the desired functionality to the end user. The third part of the description describes additional functionality and additional details of an embodiment of the system.

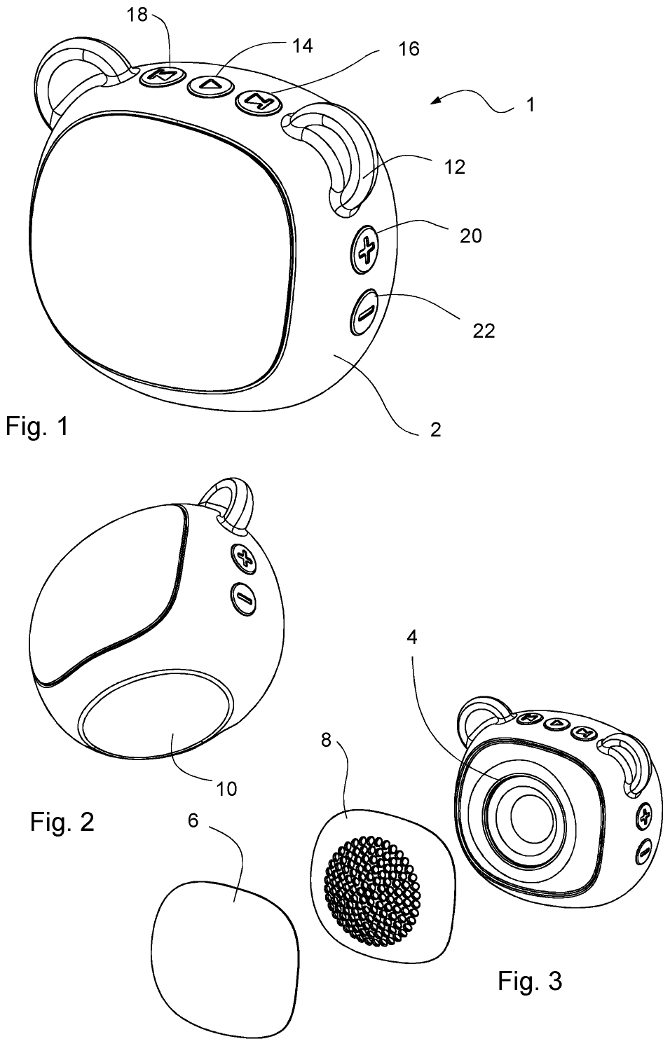

In FIGS. 1 to 6, a first embodiment 1 of a dedicated digital device, in the form of an audio device, is disclosed. The audio device comprises a housing 2, a microcomputer (arranged inside the housing) and a speaker 4. The speaker is protected behind a mesh cover 6 and a speaker grill 8. The housing has a bottom surface 10 which is flat. This flat surface allows the audio device to stand upright on a flat surface.

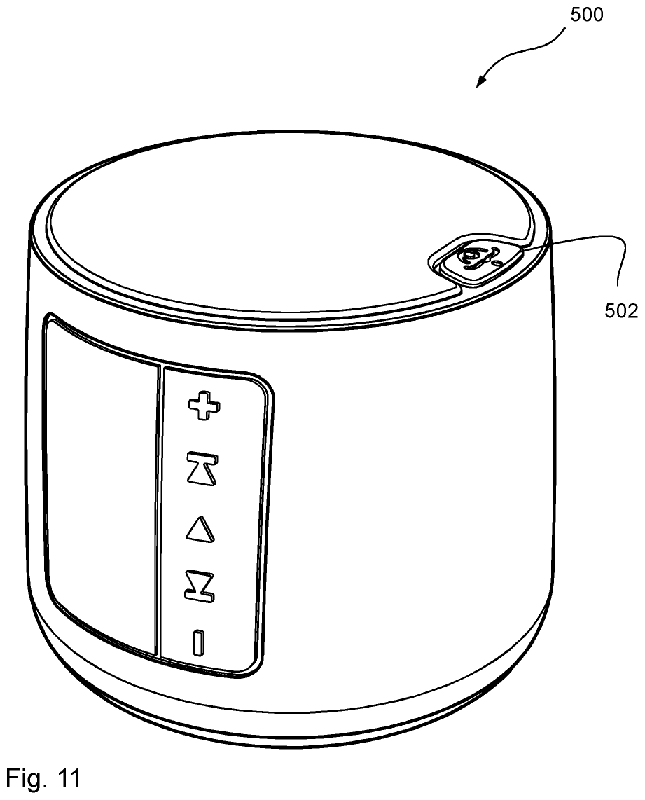

In this current embodiment, the audio device is in the shape of a bear with ears 12. However, the specific shape of the audio device is not a limiting factor and many other shapes could be imagined (see another example in FIG. 11). However, in one embodiment, the audio device could have a shape which is related to an animal.

In this embodiment, the audio device comprises a battery inside the housing and a charging connector (hidden in the views) in the form of a USB C connector. However, an embodiment without a battery could be imagined which is connected to fixed power, and embodiments with other charging connectors or inductive charging could also be imagined.

In this embodiment, the audio device also comprises an internal memory storage. In other embodiments, an external memory storage could be connected to the device, for example via an SD card or via a USB key.

In this embodiment, the audio device has five buttons, a play button 14, a next button 16, a previous button 18, a volume up button 20 and a volume down button 22.

In the current embodiment, when the play button is pressed, an audio file stored in the memory of the speaker unit will start to play. The audio file could also be streamed from a location in the cloud. When the next or previous buttons are pressed, the next or previous audio files stored in the memory start to play. It could also be that the next/previous buttons are arranged to skip to the next/previous chapters or next/previous pages if the audio file contains information related to chapters and/or pages. Or the buttons could be used to skip a certain number of seconds forwards or backwards in the audio file. In the current embodiment, the play button also works as a pause button. In an alternative embodiment, the play button could be formed as a play/pause icon as known in the art with a vertical bar and a triangle arranged beside each other.

A Near Field Communications (NFC) radio is arranged with its antenna on the bottom surface of the audio device. It is to be noted that an NFC radio is one embodiment of an RFID reader (RFID=Radio Frequency Identification). When the audio device is placed over an RFID chip or another NFC radio, the audio device can read data stored on the RFID chip or the other NFC radio. The technology related to RFID chips and NFC readers is well know in the art and won't be described in more detail here.

RFID chips can contain different amounts of data depending on the application. In the current system, a number of RFID chips are provided, each tag having a unique identifier stored in the RFID chip. Additional data can also be provided, but for the sake of the current description, only the unique identifier is used.

When the audio device is placed on top of a RFID chip, the audio device identifies the unique identifier stored in the RFID chip. The audio device then checks its internal storage to see if an audio file associated with the unique identifier is stored in the memory storage. If the audio file is stored, then the audio file is played.

If the audio file is not found, then the audio device will download the audio file from an external source, store it in the memory storage and start playback. In one case, the playback does not start until the entire file is downloaded. In another case, the playback starts as soon as enough of the file is downloaded to make audio playback possible.

In the current embodiment, the audio device has a WIFI radio and a Bluetooth radio. The audio file can be downloaded via the WIFI connection or via the Bluetooth connection. In this embodiment, in order to reduce the radiation being emitted from the device, the WIFI and Bluetooth radios are only turned on when needed. In this case, once a unique identifier is identified, and the associated audio file is not found in the memory storage, then the WIFI or Bluetooth radio is turned on, the file downloaded and then the radios are turned off again. In this way, the radios are only turned on in the specific case where a unique identifier is detected, and the associated audio file is not found on the device already. In another embodiment, the Bluetooth radio could be turned on all the time that the speaker is turned on, while only the WIFI turns on and off.

In the current embodiment, an LED light inside the play button, lights up the play button with different coloured lights in different situations. In one embodiment, whenever the Bluetooth and/or the WIFI radios are turned on, the LED will flash with a clear signal, for example, the play button will flash with a red coloured light while the radios are turned on. This provides a clear signal to a user, that the WIFI and/or Bluetooth radios are turned on. In the current embodiment, the play button lights up, but in other embodiments, other LED lights could be provided, for example an LED in the shape of a WIFI symbol.

In the current embodiment, the NFC radio on the bottom of the audio device is arranged to turn off after a short period of time. This will both save battery power and reduce the radiation from the NFC radio. In the current embodiment, the audio device comprises a small accelerometer. Whenever the accelerometer detects motion of the audio device, the NFC radio will be turned on for 5 seconds. When the accelerometer does not detect any motion, then the NFC radio will be turned off, saving power and reducing radiation. In another embodiment, the NFC radio is always on, but is provided with a tag detection feature. The NFC reader will go into a power saving mode and will only wake up when an RFID-tag is present next to the antenna of the NFC reader. In this case, an accelerometer is not necessary.

Instead of an accelerometer, motion can be detected via other forms of motion detectors. For example, motion could be detected by a tilt switch. It could also be a light sensor which detects when the audio device is lifted off a support surface. Could be a proximity sensor detecting distance to a lower surface. When the distance changes, the motion is detected.

In the current embodiment, the audio device has a WIFI module for connecting to the internet to download files from an internet connected server. The audio device also has a Bluetooth radio for connecting to a mobile device. The audio device can also function as a normal Bluetooth speaker via the Bluetooth connection. The audio device could have two Bluetooth radios, one for streaming and one, for example BLE, for secure sharing of keys when pairing with other devices like phones and WIFI SSID. In another embodiment, the speaker has only one Bluetooth radio, but it can act as both a BLE device and regular A2DP Bluetooth audio device. Other options will be known to the person skilled in the art. In one embodiment, the audio device is controlled by a mobile phone or tablet via the Bluetooth connection. In one embodiment, the audio device is connected to the internet and a cloud server, and the audio device is controlled via signals coming from the cloud server.

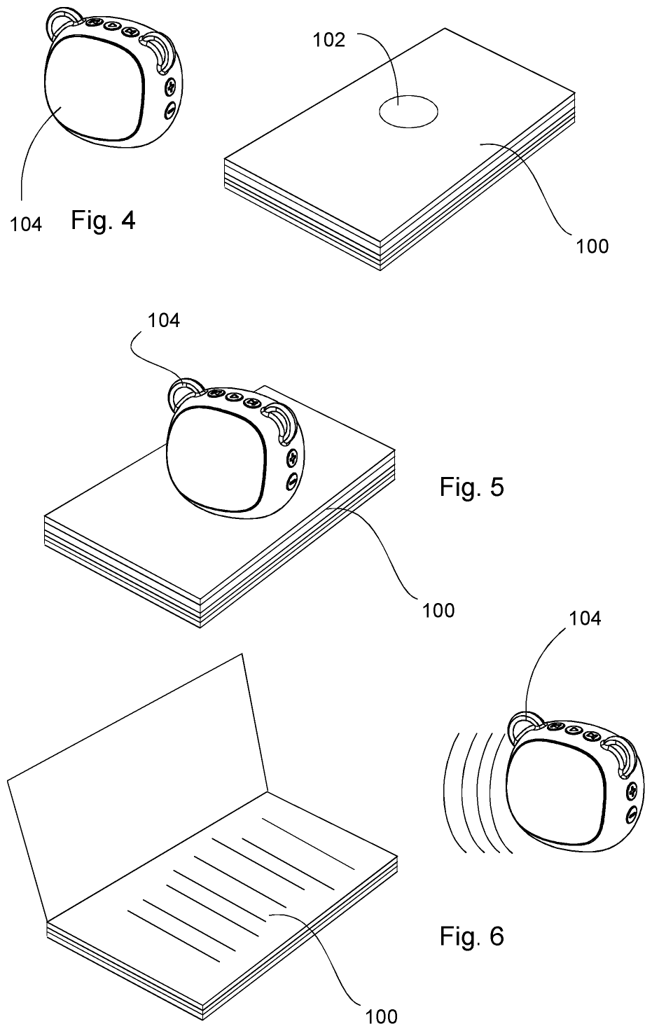

The use of the audio device according to the current embodiment is illustrated via FIGS. 4 to 6. In FIG. 4, the situation is shown where a book 100 is provided with an ID tag 102 comprising an RFID chip. The audio device 104 is arranged away from the book. In FIG. 5, the audio device is placed on top of the book and on top of the RFID chip. When the audio device is placed on the book with the RFID chip, the NFC radio will detect the tag, wakeup and read the RFID chip and identify the unique identifier stored in the RFID chip.

The audio device will then check if the file associated with the unique identifier is already downloaded. If it is, then the audio device will start to play the audio file. If it is not downloaded, then the audio device will turn on the WIFI radio, start blinking the red LED to show that the WIFI Radio is turned on, go online and download the file. The playback will start as soon as enough of the file is downloaded to start Audio playback. Once the entire file is downloaded, the WIFI radio will automatically turn off and the red blinking LED will also turn off.

In FIG. 6, it is shown that the audio device can now be removed from the RFID chip and the audio device will continue to play the audio file previously identified. The user can now read the book, look at pictures in the book or do something else with the book while the audio file continues to play. This provides for many interesting options for connecting the audio file to the book. For example, learning to read for children, learning a new language, etc. Also for blind people, the audio device could play an audio file while the book has brail letters.

Likewise, the audio device can be made an active part of the interactive experience for the reader of a book. For example, an RFID chip on one of the pages of the book could trigger a specific audio file, for example a picture of a cow could trigger a “Moo” sound when the audio device is placed on the cow. Or the audio device could say, “place me on the cow” and then a reward sound could be played when the audio device is placed on the cow. Other examples, not related to children could also be imagined, for example learning a new language etc.

In the current embodiment, the bottom surface of the audio device is flat and comprises the NFC radio antenna. In another embodiment, a sensor device could be arranged in the rear surface or another side surface of the housing. In this way, the audio device could be laid down on an object via the rear surface or a side surface to read the unique ID codes. In one example an NFC radio antenna could be located on the rear surface. This would also allow two similar audio devices to communicate with each other when placed back to back. In another embodiment, there could be an NFC radio antenna on the top surface of the speaker. In another embodiment, there could be multiple NFC antennas, for example one on the top and one on the bottom.

To get the audio device connected to the system, the audio device is first paired to a mobile phone via a Bluetooth connection and then the wifi connection details are transferred to the audio device over the Bluetooth connection.

In the embodiment shown in FIGS. 1-6, the audio device has an NFC radio which scans an RFID chip to get a unique identifier from the RFID chip. However, other forms of scanning devices could be used instead in the audio device. For example, instead of RFID chips, tags with 2D barcodes could be provided. The audio device could then have a camera device which takes a picture of the 2D barcode and gets a unique identifier from the 2D barcode.

Furthermore, in the embodiment described above a dedicated audio device has been disclosed. However, it would also be possible to enable a mobile phone or a tablet to interact with the system as well. For example, most modern mobile phones have built in NFC radios. Hence, a custom app could be loaded on the mobile phone which can use the NFC radio of the phone to read a unique identifier from an RFID chip and then go online to get the audio file associated with the unique identifier. Hence, the system of the current invention can be used both by dedicated devices and by more general purpose devices such as mobile phones and tablets.

In order to enable the above functionality, the system according to the current invention comprises a plurality of ID tags. In the current embodiment, the ID tags comprise RFID chips. Each RFID chip has a unique identifier. In the current embodiment, the unique identifier is an ID number or serial number which is unique in the plurality of tags which are in the system. The RFID chips can also comprise additional data if desired.

In this embodiment of the system, for the purpose of example, three different physical formats of RFID chips are provided. A first format is provided which is able to be embedded in a book, for example inside a cover of the book or in the spine of the book. Different options would be available to the person skilled in the art of RFID chips. A second format is provided in the form of a sticker where an RFID chip is placed on an adhesive sticker which can be applied to a book, or other object as desired. A third format is a physical object, for example, a disk like hard plastic object with an RFID chip embedded in the plastic of the object. Other formats could also be provided. It should be noted that in the current embodiment, all the different formats of ID tags comprise an RFID chip which can be scanned with an RFID scanner. Most modern telephones today comprise RFID scanners.

The system of the current embodiment also comprises an internet connected server with a database which comprises content links between unique identifiers and files comprising digital content. This will be described in more detail below. The database can be implemented in many different ways as will be known to the person skilled in the art. One example embodiment is a MySQL database hosted on a cloud server. The content links can be stored in a table in the MySQL database. In one column of the content link table, the unique ID can be provided and in a second column of the table, a link to an associated file can be provided. In order for the devices to interact with the database, a PHP based API could be provided on the cloud server. The communication between the digital devices and the API could be in JSON format. However, the actual software implementation could take many forms, as will be known to the person skilled in the art of web applications.

In the more detailed description of the audio device above, the digital content provided was an audio file. However, the digital content could also be an e-book. In the case of an e-book, the digital device would be provided with a display screen on which the e-book could be displayed. As will be clear to the person skilled in the art, other forms of digital content would also be possible.

The files containing the digital content could be located on the internet connected server or the files could be located on different servers and the internet connected server could just comprise a link to the files on the different servers. Different solutions will be known to the person skilled in the art of internet connected storage means.

When the digital device reads the ID tag, the device identifies the unique identifier, accesses the internet connected server and uploads the unique identifier to the server. The server then looks the unique identifier up in the database and sends a link to the associated file to the device. The device can then download the associated file via the link. Once the device has downloaded the file, the device can play or display the contents of the file. In certain cases, instead of downloading the entire content of the file, the device can stream the contents of the file. In this way, the device can start to play or display the contents of the file without the entire file being downloaded first. Likewise, when streaming, the local storage does not have to be very large.

As the main purpose of the current system is to link digital content with physical books, a number of the ID tags of the system are attached to physical books. The ID tags themselves are not programmed with any information related to the specific book it is attached to. The tag just contains a unique identifier. When it is desired to link the tag on the book to a specific digital file, the unique identifier of the tag is uploaded to the database together with information about the book to which it is attached. A content link will then be created in the database linking the unique identifier to a specific digital file. Thereafter, when a digital device scans the RFID chip and gets the unique identifier from the chip, the digital device can request the digital file from the server via the unique identifier.

The link can be created in different situations. In the following, three specific examples will be described which illustrate the flexibility of the current system. A first example is where the link is added by the publisher of a book, prior to the book being shipped to the stores. In this case, the publisher can provide a sticker attaching machine which attaches stickers to the books. The stickers in this case are in the form of the ID tags of the current invention. A roll of stickers can be loaded into the sticker applying machine which then attaches a number of the stickers to a number of physical books. Sticker applying machines are well known in the art and will not be described in more detail in this specification. When the roll of stickers runs out, a new roll can be attached to the machine. As the books leave the sticker machine, the unique identifiers of the ID tags can be read and uploaded to the internet connected server together with information about the book itself. The uploaded information is converted on the internet connected server into one or more links in the database between the unique identifier and a file or files associated with the particular book. The books are now programmed and linked to the relevant files. In one example, a link is created from the unique identifier to both an audio file and an e-book file. Depending on the digital device which scans the tag, either the audio file or the e-book file can be returned to the device. In order to make the registering process more convenient, a registering device specifically designed for this purpose can be provided. An embodiment of a registering device is described in more detail below.

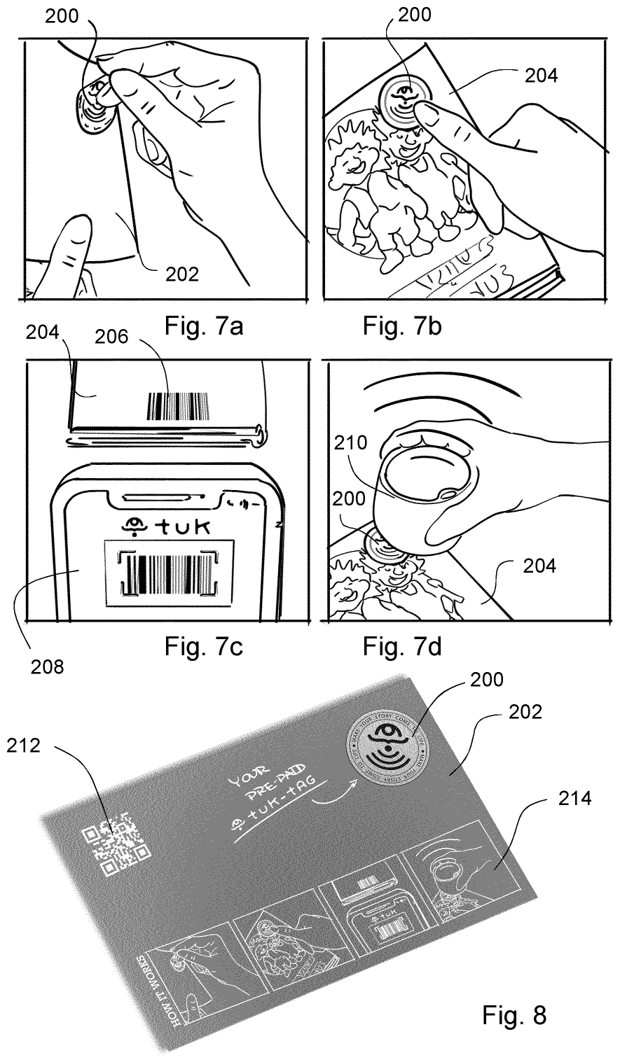

A second example is where an end user has purchased or been gifted a book a while ago and now wishes to link an audio or e-book file to the book via an ID tag according to the current invention. This example is illustrated in FIGS. 7a-7d. The user can purchase an ID tag 200 in the form of a sticker which could be mounted on a card 202 (see FIG. 8). The user can then remove the sticker from the card (FIG. 7a), attach the sticker to a book 204 (FIG. 7b), scan the ID tag to get the unique identifier of the ID tag, scan the bar code 206 of the physical book 204 with their mobile phone 208 camera and upload the unique identifier together with the barcode of the book to the internet connected server. The internet connected server could then create a link in the database between the unique identifier of the ID tag and an audio file associated with the book. The user can then use a dedicated audio device 208 to scan the ID tag on the book. The audio device will then retrieve the audio file associated with the book and play it aloud.

In the above example, the information about the book is provided by taking a picture of the ISBN barcode of the book. However, the book information could be provided by the user in different ways. Two non-limiting examples are by manually entering the title and edition/version information via a form or by providing an ISBN number directly by typing it in to a field. A search field for the title could also be provided which then displays a list of titles which match the search field. The user can then select the relevant book from the list of titles. The information about the book could also be provided by the user by taking a photograph of the cover page of the book which could then be matched against a library of cover images.

The procedure above could be implemented via a custom designed app which runs on a mobile phone. The mobile phone will have a camera to for example take a picture of the ISBN code and an NFC reader to scan the ID tag and get the unique identifier. The mobile phone and the app can then communicate with the internet connected server.

A third example is where a bookshop can “activate” a physical book when a customer purchases the physical book and the audio/e-book file together. In this case, the shop clerk could attach an ID tag to the book, scan the ID tag to get the unique identifier and then upload information about the book to the database together with the unique identifier. The shop will typically have detailed information about the book in their own internal system. This could be linked up to the database. The database can then create a link in the database which links the unique identifier and the audio/e-book file. When the customer comes home and scans the ID tag on the book, the system will return the correct audio/e-book file.

Hence, due to the proposed system, it is easy to both make new books “digital”, make old books “digital” and give extra revenue to shops since they can now sell both physical books and audio books in smart bundles.

The examples above are in general enabled by the provision of “non-linked” tags. These tags are coded with a unique identifier, but the database does not have any links associated with them at the beginning of the procedure. The “non-linked” tags can be provided to bookshops so that the shops can “activate” the tags when the books are sold to the customer. The “non-linked” tags can also be sold to end customers. In one example, a set of five “non-linked” ID tags are packaged in an envelope and sold to a customer. The customer can then apply the “non-linked” ID tags to their previously owned books and then add the link to the audio files as described above. It is to be noted that in certain cases, the user would need to purchase access to the audio or e-book file prior to being able to add the link.

In certain cases, it is desired to provide more access control to the digital content to prevent unauthorized use of the digital content. For example, it is desired to limit the use of the digital content to a specific user which purchased the digital content. In one embodiment, this is provided by providing data representing user accounts in the database. In order to access digital content, the user first needs to create a user account in the system and then link their purchased digital content to their user account. Therefore, only digital content which is “owned” by the user can be played on digital devices which are associated with the user account. The specific digital devices owned by a user could be directly linked to the user's user account. In this way, all the devices owned by the user could be allowed to playback the digital content owned by the user.

In a more specific example, a database could be provided on the internet connected server with a table of user accounts. When a user purchases a digital content, an ID tag with a unique identifier is linked to the digital content. The unique identifier associated with the ID tag is then also linked to the user account. When the user requests playback of the file, the system checks to see if the unique identifier is linked to the user account. If not, then the playback is not allowed. If the link is there, then the user can playback the content.

In order for the user to purchase digital content, the user account could be provided with a credit system representing money. The user can add money to his or her account by adding credits to the account. Credits can be added in typical ways, for example via a credit card payment to the account or by linking a credit card to a user account. Then when the user wishes to purchase digital content, the money for the digital content can be deducted from the user account directly or via the credit card linked to the user account. One example procedure would be for a user to create an account and then link their credit card to the account. The user could then get an ID tag, attached it to a book and then scan the ISBN code of the book to which the ID tag is attached. The system could then identify the book and propose an audio file associated with the book. The system can then inform the user of the price of the audio file. The user can accept the price and the system will deduct the money from the user's credit card. Once the payment is made, then the system creates a link between the unique identifier and the audio file and adds it to the user's user account.

In the current embodiment of the system, the database could also link specific unique identifiers of ID tags to actions or procedures instead of to digital content. These types of links could be called action links instead of content links. For example, the tag could be linked to a procedure which is programmed to cause the digital device to pause the playback if the tag is scanned. In another example, the tag could be linked to a procedure which causes an alarm to be set on the digital device. The benefit of this system is that the same types of stickers can be associated with both content and actions. This also makes the system more flexible for users since the stickers can also be used to trigger actions.

These actions can also be associated with a specific ID tag by the users themselves in an easy manner. For example, a user can buy an empty tag, attach it to his/her bedside table and then via an app of the system, associate a specific action with the tag. For example, the user could start the “action assign procedure” in the app. The app could then ask the user to choose what action was desired from a list of predefined actions. The user could then choose an action. The app could then ask the user to scan the ID tag. The user would then scan the ID tag. The system would then create a link in the database between the unique identifier of the ID tag and the chosen procedure. In one example, the user could add a tag to the bed of his/her child and associate a bedtime song with the tag. When the child scans the tag, the speaker unit would start to play the bed time song. Likewise, the user could attach a tag to the desk of his/her child and when the tag is scanned, the speaker unit could start a timer for 20 minutes to help the child concentrate. In this way, the Pomodoro technique could be implemented for a child in a fun and easy way.

If the previously linked action is no longer desired, then the user can unlink the tag from the previous action and link the tag to a new action.

Such action tags could also be associated with an action which adds a financial amount to the user's account. For example, an ID tag could be provided which is linked to an amount of 5 EUR. When the tag is scanned, 5 EUR is added to the user's account. Once the amount has been added, then the link linking the ID tag and the 5 EUR procedure can be deactivated so that the user cannot run the same 5 EUR procedure multiple times.

In practice the database could have a list of different procedures. For example there could be a 5 EUR procedure, a 10 EUR procedure, a set alarm procedure, a set timer procedure, etc. In the database, the unique identifier of one ID tag could be linked to the 5 EUR procedure. When the tag is scanned, the 5 EUR procedure is performed and then the link removed. Hence, the system is very flexible. This is great for gift certificates.

It is also a benefit of the system that the same tags can be used both for actions and content links, since the same tag can easily be reprogrammed from an action tag to a content tag. In one example, illustrated in FIG. 8, a card 202 is provided with a sticker 200 attached to the card. The sticker can be removed from the card by peeling it off the card and then applying it to a book. The sticker on the card can be associated with a financial amount procedure as described above. For example it could be linked to a 5 EUR amount. When the user scans the tag, the amount of 5 EUR could be transferred to the users account. Once the tag is read, the procedure could then ask the user to scan the ISBN code of the book, after which the system removes the action link to the 5 EUR action in the database and replaces it with a link to the audio file associated with the identified book. In this way, the user can purchase an audio file associated with a book without the need for linking a credit card or depositing money into their account.

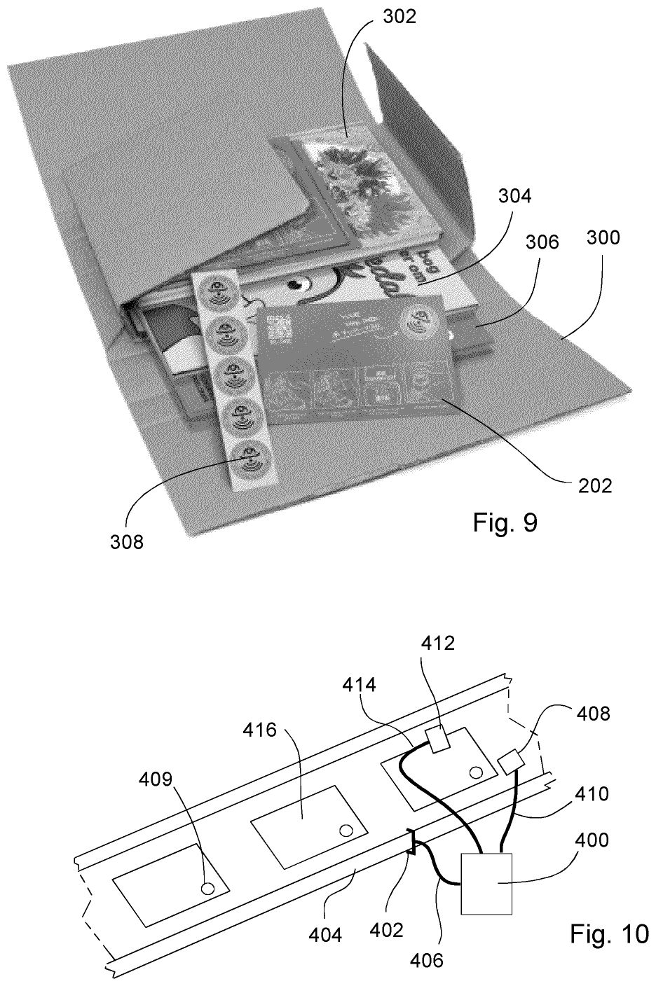

FIG. 9 shows an example of a bundle of products which could be supplied as a part of the invention. In this example, a cardboard packaging 300 is provided as packaging to protect the contents of the package during shipping. The package contains three books 302, 304, 306, three separate cards with prepaid ID tags in the form of cards 202 with stickers 200 and five generic ID tags 308, also in the form of stickers. The cards with the tags can be used as described above. The generic tags can be programmed to link to actions or to books as desired. A user could for example add a tag to a child's bedside which is linked to the child's favourite book as well as having a tag on the book itself. Then the child can either scan the tag by the bed or the tag on the book and both tags will trigger playback of the same audio file.

FIG. 10 shows a very schematic example of a registering device as provided by the current specification. The registering device 400 could be in the form of a mobile phone like device. The device has a screen (not shown) and is able to communicate with an internet connected server. The device comprises a bracket 402 which can be attached to, for example, a conveyor frame 404 of a sticker attaching machine. The bracket is connected to the device via a flexible arm 406. The device also comprises a scanner 408 for scanning ID tags 409 to read the unique identifier on the tag. The scanner 408 is also attached to the registering device via a flexible arm 410. The registering device also comprises a camera 412 which is also attached to the registering device via a flexible arm 414. The camera takes pictures of a book 416 passing the camera on the conveyor. The picture and the unique identifier are then synchronized and uploaded together to the internet connected server. The internet connected server can then generate a link between the ID tag and the book. This information can make the system more flexible for the user, since the end user does not need to associate the book with the tag, this is already done by the publisher. Due to the use of flexible arms, it is very easy to adapt the registering device to different machines, different book sizes, different sticker placements, etc.

FIG. 11 shows a perspective view of a second embodiment of a dedicated audio device 500 associated with the system according to the current invention. The device is very similar in function to the audio device 1 shown in FIGS. 1-6. As such the functionality will not be described in detail. However, this embodiment 500 has an extra functionality implemented by a “Page change” button 502. This button is provided to allow a user to add information about page changes to the audio file associated with a book. In general, audio books do not have any information associated with pages, since the audio book is usually just an audio file with an audio recording of somebody reading the book. Hence, there is usually no need for page information. However, when the book is read aloud while a user is reading along in the physical book, for example a child learning to read, a child reading a picture book or an adult learning a new language, the page turn information can be very relevant.

Hence, in the current embodiment, the “page change” button 502 is provided to be able to add page change information to the audio file. The page change information is added manually by a user of the system, for example a parent of a child. The user can start the audio playback and then make a long press on the page change button to put the audio device into “Page change” learning mode. The user can then follow along when the audio file is played back and every time the page needs to be turned in the physical book, the user can press the “Page change” button 502. When the page change button is pressed, the audio device makes a time stamp in a page change table associated with the audio file. When the parent has finished the book, then the page change table associated with the audio file will have a number of time stamps representing page change locations in the audio file. When the child listens to the audio book the next time, the audio device can play a page change sound when the time stamps are identified in the table.

In order to make the page change learning function faster, the audio device could be arranged to play back the audio faster than normal when put into page change learning mode, so that the page change information can be more quickly programmed into the device.

In one embodiment, the page change table associated with the audio file could be uploaded to the internet connected server. The internet connected server could then store this information together with the audio file. The data can then be provided for the user's different devices, not just the dedicated device.

Furthermore, as more and more users upload page change data for the same book to the system, the system can make a statistical analysis of the data and identify groups of time stamps. If enough users have made an entry at roughly the same time, then the system can treat this as a verified page change time stamp. Once enough data has been collected from enough users to ensure accuracy, the page change data could be offered to new users as an add on. Instead of having to manually add the page change data, they can purchase it is a value add. In certain cases, the data could be made available for free to improve the value of the audio file.

It is to be noted that the figures and the above description have shown/described the example embodiments in a simple and schematic manner. Many of the more specific details have not been shown since the person skilled in the art should be familiar with these details and they would just unnecessarily complicate this description. For example, the specific materials used, the specific electronic components used and the specific software used have not been described in detail since it is maintained that the person skilled in the art would be able to find suitable materials, electronic components and software to provide the system and the devices according to the current invention.

1. System for linking digital content with physical books, said system comprising:
a. a plurality of ID tags, each of the ID tags of said plurality of ID tags comprising a unique identifier associated with the ID tag, said ID tag being configured to be scannable by a scanner to identify the unique identifier associated with the ID tag, at least some ID tags from said plurality of ID tags being physically attached to a plurality of physical books and at least some ID tags of said plurality of ID tags not being physically attached to physical books,
b. a network connected service, said service comprising:
i. a database which comprises data representing a plurality of content links between unique identifiers of ID tags of said plurality of ID tags and files comprising digital content,
c. said system being arranged to allow a plurality of digital devices to interact with the system, each of said digital devices comprising:
i. a speaker and/or a display to play and/or display digital audio content and/or digital visual content respectively,
ii. a communication unit to allow the digital device to communicate with the network connected service,
iii. a scanner arranged to scan an ID tag of said plurality of ID tags and identify the unique identifier associated with the scanned ID tag, and
iv. a microprocessor arranged to access the network connected service via the communication unit,
d. said network connected service being configured to execute a content retrieving procedure, said content retrieving procedure facilitating, at least in part, the steps of a digital device contacting the network connected service, the digital device uploading a unique identifier to the network connected service and the digital device retrieving a file comprising digital content which is linked with the uploaded unique identifier via the data representing the plurality of content links in the database.

2. System according to claim 1, wherein
a. the plurality of digital devices which are able to interact with the system comprises:
i. audio devices with a speaker, and
ii. display devices with a display,
b. said data representing a plurality of content links between unique identifiers associated with ID tags of said plurality of ID tags and files comprising digital content comprising:
i. audio content links between unique identifiers and files comprising audio recordings, and
ii. display content links between unique identifiers and files comprising e-books,
c. said audio devices being arranged to play the files comprising audio recordings and said display devices being arranged to display the files comprising e-books.

3. System according to claim 1, wherein at least some ID tags of said plurality of ID tags are stickers comprising a foil wafer having a first main surface with an adhesive suitable for physically attaching the foil wafer to a surface of a physical book.

4. System according to claim 1, wherein at least some ID tags of said plurality of ID tags are non-linked ID tags where the database does not comprise a content link between the unique identifier associated with the non-linked ID tags and any particular files comprising digital content or the database comprises a content link between the unique identifier associated with the non-linked ID tags and a placeholder digital content.

5. System according to claim 1, wherein said network connected service is configured to execute at least a part of a content link creation procedure which creates a content link between a specific file comprising digital content and a unique identifier associated with an ID tag of said plurality of ID tags.

6. System according to claim 5, wherein the content link creation procedure is triggered by at least one of said plurality of digital devices.

7. System according to claim 1, wherein the database further comprises data representing information about a plurality of user accounts and in that the database further comprises data representing user account links between at least some unique identifiers associated with at least some ID tags of said plurality of ID tags and at least some user accounts in the database.

8. System according to claim 1, wherein the database comprises data associated with each ID tag of said plurality of ID tags which represents a type of tag and/or a tag status to define the way in which the system treats the tag.

9. System according to claim 1, wherein the database further comprises data representing action links between unique identifiers associated with some ID tags of said plurality of ID tags and predefined procedures.

10. System according to claim 1, wherein the database comprises data representing a plurality of book information records, said book information records comprising information related to the title of the book, the edition/version information and links to related digital content, said unique identifiers linking an ID tag to a book information record.

11. System according to claim 1, wherein the plurality of ID tags comprises a first type of ID tag which is embedded in a part of a physical book and a second type of ID tag which is in the form of a sticker attached to a surface of a physical book.

12. System according to claim 11, wherein the two types of ID tags are scannable by the same type of scanner.

13. System according to claim 12, wherein the two types of ID tags both comprise an RFID chip which is scannable by an RFID scanner.

14. System according to claim 1, wherein at least some ID tags of said plurality of ID tags are physically attached to physical elements which are not physical books.

15. System according to claim 14, wherein said physical elements are plastic figures and the ID tag is embedded in the plastic figures.

16. System according to claim 14, wherein at least some ID tags of said plurality of ID tags are attached to physical books via a sticker, at least some ID tags of said plurality of ID tags are embedded in physical books and at least some ID tags of said plurality of ID tags are embedded in physical elements other than physical books.

17. System according to claim 4, wherein multiple different physical books with non-linked tags link to the same “placeholder digital content”.

18. System according to claim 4, wherein at least some of said non-linked ID tags are attached to physical books.

19. System according to claim 18, wherein at least some of said physical books with attached non-linked ID tags are provided for sale in a shop or are located in the home of a consumer.

20. System according to claim 4, wherein at least some of said non-linked ID tags are not physically attached to any physical book and are packaged in packaging suitable for sale in a physical store and/or suitable for shipping via mail.

21. System according to claim 20, wherein a set of two or more non-linked ID tags are not physically attached to any physical books and are packaged together in a packaging suitable for sale in a physical store and/or suitable for shipping via mail.

22. System according to claim 20, wherein said system comprises a plurality of sets of more than one and less than 10 non-linked ID tags which are not physically attached to any physical books and are packaged together in a packaging suitable for sale in a physical store and/or suitable for shipping via mail.

23. System according to claim 4, wherein the system comprises a kit of parts comprising a packaging, at least one physical book and at least one non-linked ID tag arranged inside the packaging, said at least one non-linked ID tag not being physically attached to the physical book.

24. System according to claim 9, wherein the system is configured to execute a predefined procedure where the database is changed such that an action link associated with a unique identifier is replaced with a content link.

25. System according to claim 9, wherein at least one predefined procedure comprises the steps of: receiving data representing an ID of a user account from a digital device and adding data representing credits to the user account, said credits being suitable for purchasing digital content, the amount of said credits to be added being defined in the at least one predefined procedure.

26. System according to claim 9, wherein at least one of said predefined procedures, does not include retrieving a link to digital content or retrieving or playing/displaying digital content associated with the unique identifier of the ID-tag.

27. System according to claim 1, wherein said system further comprises a registering device comprising a scanner suitable for scanning a unique identifier associated with an ID tag of said plurality of ID tags physically attached to a physical book, a book identifying unit arranged to identify data representing the title and edition/version of a physical book, a communication device suitable for communicating with a network connected service of a system as described above, and a microprocessor configured to upload the scanned unique identifier and the identified data representing the title and edition/version of the physical book to the network connected service.

28. System according to claim 27, wherein said registering device is a portable device comprising a fastening mechanism for fastening said registering device to a machine in the book production process.

29. System according to claim 27, wherein the book identifying unit comprises a camera configured to take one or more pictures of the cover of a physical book and/or of the ISBN bar code on a physical book.

30. System according to claim 27, wherein the microprocessor is configured to upload a picture of the cover of the physical book and/or the ISBN bar code together with the unique identifier associated with the scanned ID tag to the network connected service where the network connected service is configured to execute or perform (at least a part of) a procedure to match the uploaded picture with a title and edition/version of a physical book.

31. System according to claim 27, wherein the registering device comprises a camera configured to take pictures of the cover of a book or of the ISBN bar code on a book and where the book identifying unit is configured to execute a procedure to match a picture of the book with a title and edition/version of the book and upload data representing the identified title and version/edition information to the network connected service with the scanned unique identifier of the ID tag.
